(19) United States
(12) Patent Application Publication
(10) Pub. No.: US 2006/0159187 A1
(43) Pub. Date: Jul. 20, 2006

(54) System and method for utilizing different known guard intervals in single/multiple carrier communication systems

(76) Inventors: Haifeng Wang, Oulu (FI); Wei Li, Nanjing (CN); Ming Chen, Nanjing (CN); Shixin Cheng, Nanjing (CN)

Correspondence Address: Hollingsworth & Funk, LLC;Suite 125, 8009 34th Avenue South, Minneapolis, MN, 55425, US

(21) Appl. No.: 11/036,588

(22) Filed: Jan. 14, 2005

(51) Int. Cl. H04K 1/10; H04B 1/10

(52) U.S. Cl. 375/260; 375/350

(57) ABSTRACT

A system and method for a transceiver structure, where Different Known Guard Intervals (DKGI) are appended to multiple, consecutive data blocks and are then used in combination with Channel State Information (CSI) to restore cyclic convolution in the time domain. Once restored, the CSI and cyclic convolution are transformed into the frequency domain by FFT processing to facilitate equalization of the channel through Frequency Domain Equalization (FDE). Through performance of time domain channel estimation, there is no need for pilot signals and related overhead, thus channel capacity is enhanced.

### FIELD OF THE INVENTION

This invention relates in general to wireless communication systems, and more particularly to a system and method for mitigating multi-path fading in wireless communication systems.

### BACKGROUND OF THE INVENTION

Recent interest in the convergence of mobile wireless and local wireless access systems has spawned much research and development in Beyond Third Generation (B3G) Wireless and Fourth Generation (4G) Mobile (B3G/4G) technologies. Many B3G/4G related technologies such as radio transmission, wireless application protocols, ALL-IP wireless network architectures, and super signal processing have enjoyed similar research and development effort.

Unlike its second generation (2G) predecessor, the 3G, and emerging B3G/4G technologies are all based on Code Division Multiple Access (CDMA). Accordingly, much of the research and development has been devoted to communication improvements at the physical transmission layer. In a CDMA system, each user's signal energy is continuously distributed throughout the entire time-frequency plane, whereby each user shares the entire time-frequency plane by employing a wideband coded signaling waveform. Thus, the number of users that may be simultaneously accommodated in a CDMA system is not bounded by the number of timeslots available within the time-frequency plane, as in a Time Division Multiple Access (TDMA) system, but is rather a function of the number of users present within the communication channel and the amount of Processing Gain (PG) employed by the CDMA system.

As with all wireless communication systems, CDMA is plagued by a phenomenon known as multipath fading, whereby a transmitted signal arrives at the receiver via more than one path due to reflection, refraction, and scattering of the radio waves. Transmitted signals that are subjected to multipath fading suffer from Inter-Symbol Interference (ISI), and are thereby drastically degraded through amplitude fluctuation, phase distortion, and propagation delay spread.

The Time Domain Equalizer (TDE) has been widely used to mitigate the effects of ISI in CDMA systems. The TDE algorithm, however, may be prohibitively complex, since the required number of multiplications per symbol is proportional to the number of channel impulse responses. Accordingly, a Frequency Domain Equalization (FDE) technique has been proposed with significantly less complexity. In particular, a Guard Interval Inserted Structure (GIIS) is used to eliminate the multipath impacts for Single-Carrier (SC) and Multi-Carrier (MC) systems, where the GIIS can be broken down into 3 types: Cyclic Prefix (CP), Zero Padding (ZP), and Fixed symbol Padding (FP).

Using the CP variation of GIIS, each data block is appended with a repetition of the last data symbols in each data block, where the repetition results in a redundancy that is greater than the maximum delay spread, i.e., length of the channel impulse response. At the receiver side, the repeated symbols are removed based on time synchronization in order to avoid Inter-Block Interference (IBI). The result is then Fast Fourier Transform (FFT) processed, where the frequency selective channel is transformed into parallel, flat-faded independent sub-carriers, so that the frequency selective channel may be equalized by a one-tap FDE.

Using the ZP variation of GIIS, symbol recovery is ensured regardless of the channel zero locations. Before transmission, each data block is appended with zero valued symbols having a length greater than the maximum delay spread, where the redundancy is inserted in the form of zero padding. Such a redundancy, however, causes a substantial discontinuity due to the appended zeros, which accordingly requires high performance from the power amplifiers on the transmission side.

Both the CP and ZP schemes provide FDE by adding a Guard Interval (GI) to convert the circular convolution between the channel and the signals into cyclic convolution. However, pilot signals are still needed in order to obtain reasonable channel estimation. Thus, the CP and ZP schemes are most widely utilized for their frame synchronization attributes, but are not robust enough for time domain channel estimation.

The FP scheme transforms the linear convolution between transmitted signal and multipath channel into cyclic convolution by appending fixed known symbols at both sides of the data blocks. Thus, by using the FP scheme, the fixed known symbols may be utilized for channel estimation, or ISI cancellation in the time domain, if required. The channel capacity is reduced, however, due to the requirement of fixed known symbols at both sides of the data blocks.

Accordingly, there is a need in the communications industry for a GIIS system and method that allows channel estimation to be performed in the time domain, thus obviating the need for pilot signals to be used in the frequency domain while increasing channel capacity as compared to conventional CP, ZP, and FP schemes. The present invention fulfills these and other needs, and offers other advantages over the prior art TDE/FDE approaches.

### SUMMARY OF THE INVENTION

To overcome limitations in the prior art described above, and to overcome other limitations that will become apparent upon reading and understanding the present specification, the present invention discloses a system and method for single/multiple carrier communications, in which Different Known Guard Intervals (DKGI) and Channel State Information (CSI) are used to restore cyclic convolution in the time domain. The present invention facilitates FFT transformation of the cyclic convolution restored signal into the frequency domain, which enables channel equalization via Frequency Domain Equalization (FDE). The present invention thus allows time domain channel estimation techniques to be employed, which eliminates pilot signal overhead to enhance channel capacity.

In accordance with one embodiment of the invention, a method of performing Frequency Domain Equalization (FDE) comprises receiving a variable number of concatenated data blocks, receiving a Different Known Guard Interval (DKGI) appended to each one of the concatenated data blocks, estimating Channel State Information (CSI) of the channel in the time-domain using the received DKGI, and restoring cyclic convolution using the estimated CSI and the received DKGI to facilitate frequency domain equalization.

In another embodiment of the invention, a communication system adapted to remove multipath fading effects of a communication channel from a received transmission signal comprising a transmitter that is coupled to the communication channel and is adapted to append a variable number of data blocks with Different Known Guard Intervals (DKGI) to form the transmission signal. The communication system further comprises a receiver that is coupled to receive the transmission signal from the communication channel and is adapted to separate the data blocks from the DKGI. The receiver includes a channel state estimation module that is coupled to receive the DKGI and is adapted to estimate channel state information in the time domain from the DKGI. The receiver further includes a cyclic convolution restoration module that is coupled to the channel state estimation module and is adapted to restore cyclic convolution using the estimated channel state information and the DKGI.

In another embodiment of the invention, a mobile terminal capable of being wirelessly coupled to an entity within a communication system comprises a memory that is capable of storing a Different Known Guard Interval (DKGI) module, a processor that is coupled to the memory and is adapted by the DKGI module to append a first set of DKGIs to a first variable number of data blocks to form a first transmission signal, and a transceiver that is configured to transmit the first transmission signal to the entity. The transceiver includes a receiver that is coupled to receive a second transmission signal from the entity having a second set of DKGIs and is adapted by the processor to estimate channel state information in the time domain from the second set of DKGIs and is further adapted to restore cyclic convolution using the estimated channel state information and the second set of DKGIs.

In another embodiment of the invention, a computer-readable medium having instructions stored thereon which are executable by a mobile terminal for substantially equalizing multipath effects on a signal received from a transmitting entity via a channel. The instructions perform steps comprising separating a Different Known Guard Interval (DKGI) from a variable number of data blocks transmitted by the entity, estimating Channel State Information (CSI) of the channel in the time-domain using the DKGI, and restoring cyclic convolution using the estimated CSI and DKGI to facilitate frequency domain equalization.

In another embodiment of the invention, a base station within a wireless communication network is adapted to receive transmissions from a mobile terminal. The base station comprises a receiver that is adapted to separate a variable number of data blocks from an appended Different Known Guard Interval (DKGI) received from the mobile terminal. The receiver includes a channel state estimation module that is adapted to estimate channel state information in the time domain from the DKGI and a cyclic convolution restoration module that is coupled to the channel state estimation module and is adapted to restore cyclic convolution using the estimated channel state information and the DKGI.

In another embodiment of the invention, a computer-readable medium having instructions stored thereon which are executable by a base station for substantially equalizing multipath effects on a signal received from a mobile terminal via a channel. The instructions performing steps comprising separating a Different Known Guard Interval (DKGI) from a variable number of data blocks transmitted by the mobile terminal, estimating Channel State Information (CSI) of the channel in the time-domain using the DKGI, and restoring cyclic convolution using the estimated CSI and DKGI to facilitate frequency domain equalization.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems and methods in accordance with the invention.

### BRIEF DESCRIPTION OF THE DRAWINGS

The invention is described in connection with the embodiments illustrated in the following diagrams.

FIG. 1A represents a graphical representation of the concatenation of consecutive data blocks with their respective guard intervals in accordance with the present invention;

FIG. 1B illustrates an exemplary receiving end of a multi-carrier system in accordance with the present invention;

FIG. 2 illustrates an exemplary block diagram of a transceiver in accordance with the present invention;

FIG. 3 illustrates an exemplary block diagram of the Different Known Guard Interval Insertion (DKGII) block of FIG. 2;

FIG. 4 illustrates an exemplary block diagram of the Different Known Guard Interval Removal (DKGIR) block of FIG. 2;

FIG. 5 illustrates exemplary block diagrams of the cyclic convolution restoral and channel state information blocks of FIG. 2;

FIG. 6 illustrates a representative mobile computing arrangement suitable for communications in accordance with the present invention; and

FIG. 7 is a representative computing system capable of carrying out base station operations according to the present invention.

### DETAILED DESCRIPTION OF EMBODIMENTS OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention provides a transceiver structure for single/multi-carrier communications. Different Known Guard Intervals (DKGI) are appended to multiple, consecutive data blocks and are then used in combination with Channel State Information (CSI) to restore cyclic convolution in the time domain. Once restored, the CSI and cyclic convolution are transformed into the frequency domain by FFT processing to facilitate equalization of the channel through Frequency Domain Equalization (FDE). Through performance of time domain channel estimation, there is no need for pilot signals and related overhead, thus channel capacity is enhanced as compared to prior art solutions, such as Orthogonal Frequency Division Multiplexing (OFDM) with Cyclic Prefix (CP) and Single Carrier Cyclic Prefix (SCCP).

Inter-Symbol Interference (ISI) arises from the fact that the channel performs a linear convolution of its impulse response with a time-domain waveform, where the time-domain waveform consists of data blocks, or symbols, which have been mirrored, optionally Inverse Fast Fourier Transform (IFFT) processed depending on the carrier system being utilized, and concatenated. At the intersection of adjacent symbols, the linear convolution of the time-domain signal with the channel impulse response overlaps parts of both symbols, whereby previously independent symbols affect each other, or in other terms, “bleed” into one another.

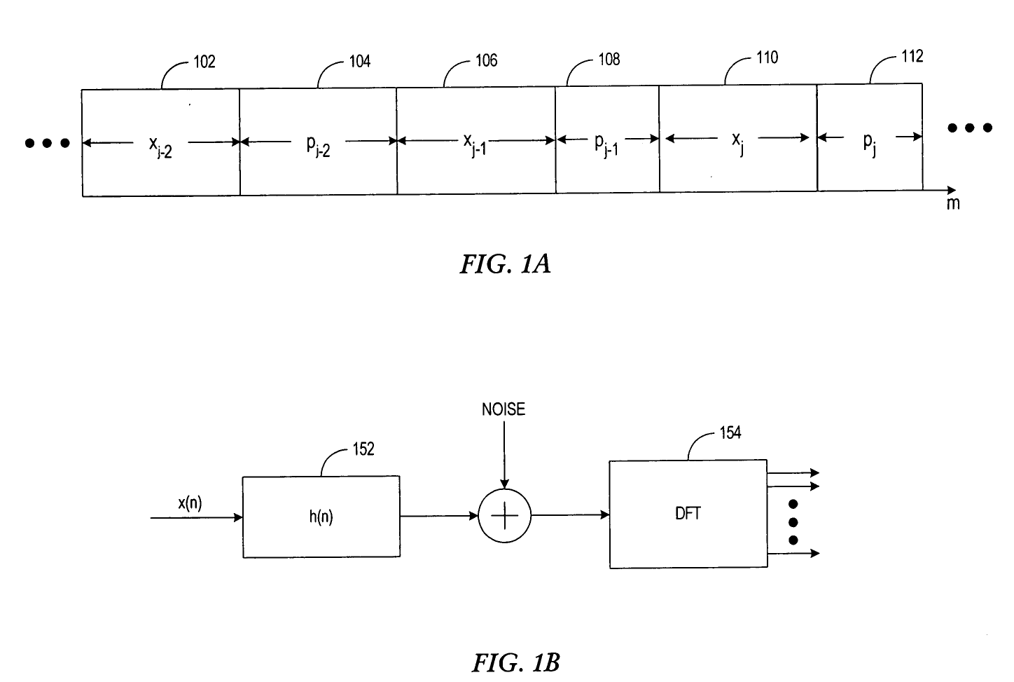

FIG. 1A illustrates a graphical representation of the concatenation of consecutive data blocks, xⱼ(m), with their respective different guard intervals, pⱼ(m). A variable number of data blocks 102, 106, and 110 are appended by different guard intervals 104, 108, and 112, respectively. As will be discussed in more detail below, the actual length of the guard interval used and the number of consecutive data blocks that are to be concatenated is to be defined in order to reach the best trade-off between the channel capacity waste and end user mobility.

Inter-Channel Interference (ICI) is an additional adverse phenomenon caused by the channel, in which carrier frequencies lose their orthogonality due to the channel's frequency response. In particular, spectral content at the input to the channel may be characterized as a plurality of sinc functions centered at each carrier frequency because the transmitter modulates each carrier frequency with a rectangular pulse. Since the basis of the Discrete Fourier Transform (DFT) is orthonormal, the basis vectors, or sinusoids, modulated by the DFT are also orthonormal, i.e., they have a zero inner product. The channel, however, attenuates certain frequencies more than others, so that each of the sinc functions is altered by a different amount. Since the inner product is a measure of the similarity between two vectors, two previously dissimilar sinc functions may now exhibit at least some degree of similarity, i.e., the orthogonality between the sinc functions is destroyed by the channel. Without orthogonal carriers, the FFT at the receiver cannot exactly recover the correct spectral coefficients.

FIG. 1B illustrates the receiving end of an exemplary multi-carrier system in accordance with the present invention. Data symbols, x(n), are transmitted through channel 152 having impulse response h(n) with length Lₕ. The notations on the input symbols needs to be extended with an index, i, so that inputs corresponding to the present symbol, xᵢ(n), which gives rise to the ICI, and the previous data symbol, xᵢ₋₁(n), which causes the ISI, can be differentiated. The multiple carriers are extracted at the receiving end by DFT processing 154.

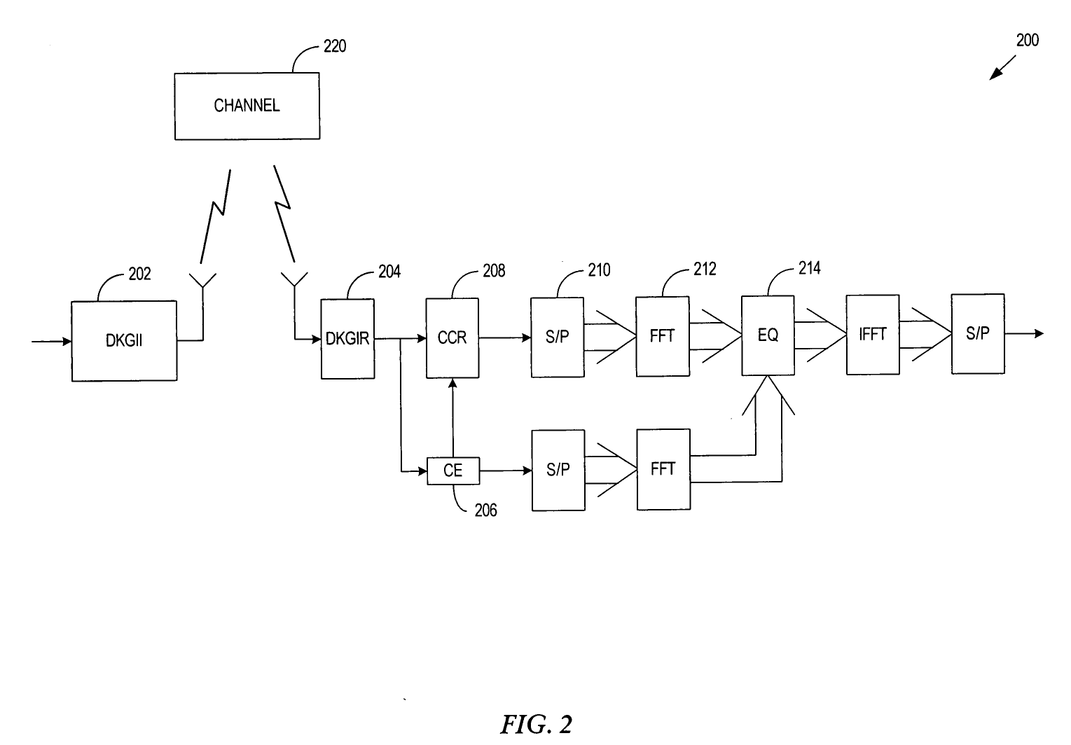

FIG. 2 illustrates an exemplary block diagram of transceiver 200 in accordance with the present invention, in which DKGIs for consecutive data blocks are utilized as illustrated in FIG. 1A. During the i^{th} data period, Different Known Guard Interval Insertion (DKGII) block 202 appends a predefined, known Guard Interval (GI), pᵢ(m), to the i^{th} data block as follows:

$${b}_{i} ( m ) = \{ \begin{matrix}{x}_{i} ( m ) & m = 0 , 1 , ⋯ , M - L - 1 \\ {p}_{i} ( m - M ) & m = M - L , ⋯ , M - 1\end{matrix} , \qquad ( 1 )$$

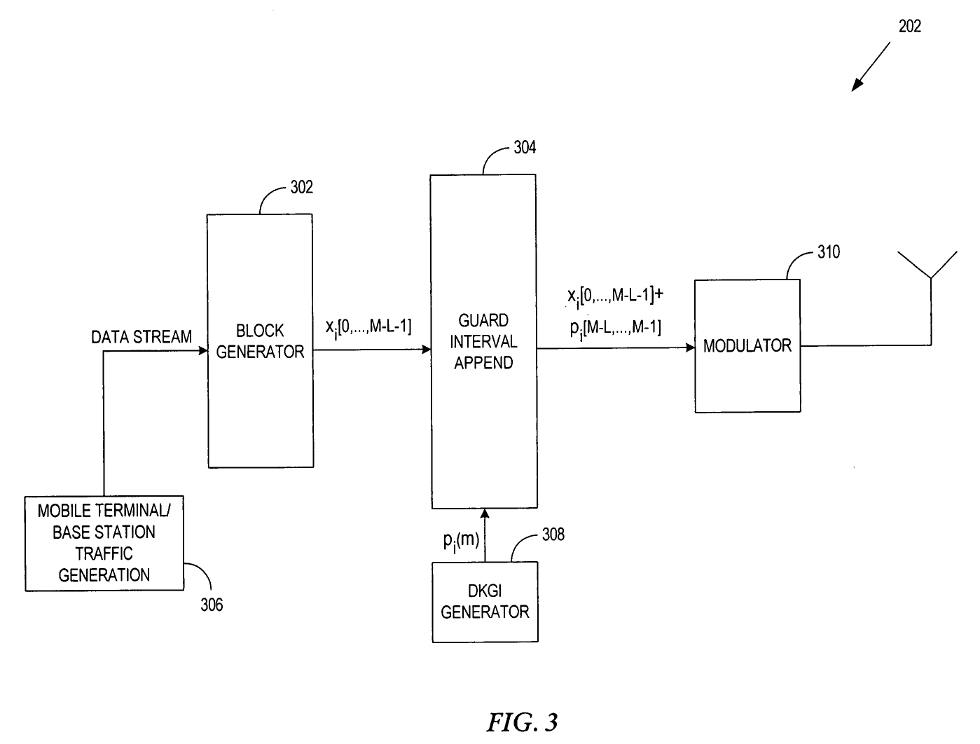

as exemplified by DKGII block diagram 202 of FIG. 3.

In particular, as DKGII block 202 may exist in either of a mobile terminal transmitter or a base station transmitter, block generator 302 is adapted to collect serial data streams from either mobile terminal or a base station generator 306. The collected serial data streams may, therefore, be clocked at any of the known CDMA transmission rates, as well as any of the developing CDMA transmission rates that are as of yet unknown. In addition, the serial data may be combined as necessary to form data symbols in support of any modulation format as required by the CDMA system, such as Quadrature Phase Shift Keying (QPSK) or Quadrature Amplitude Modulation (QAM) to name only a few.

Block generator 302 receives a serial data stream from mobile terminal/base station traffic generation block 306 and formulates blocks of data, xᵢ(m), from the serial data streams. The i^{th} data block is appended by GI append block 304 with a corresponding, predefined known guard interval, pᵢ(m), that is generated by DKGI generator 308. The concatenated block, bᵢ(m)=xᵢ(m)+pⱼ(m), has a total length of M+L, where the block length attributable to the consecutive data blocks is equal to M and the block length attributable to the GI is L. The number of consecutive data blocks, M, is proportional to the Doppler frequency of channel 220 of FIG. 2. The appended data blocks are then modulated and up-converted to form the transmitted waveform as required by the particular modulation scheme being utilized for single/multi-carrier communications.

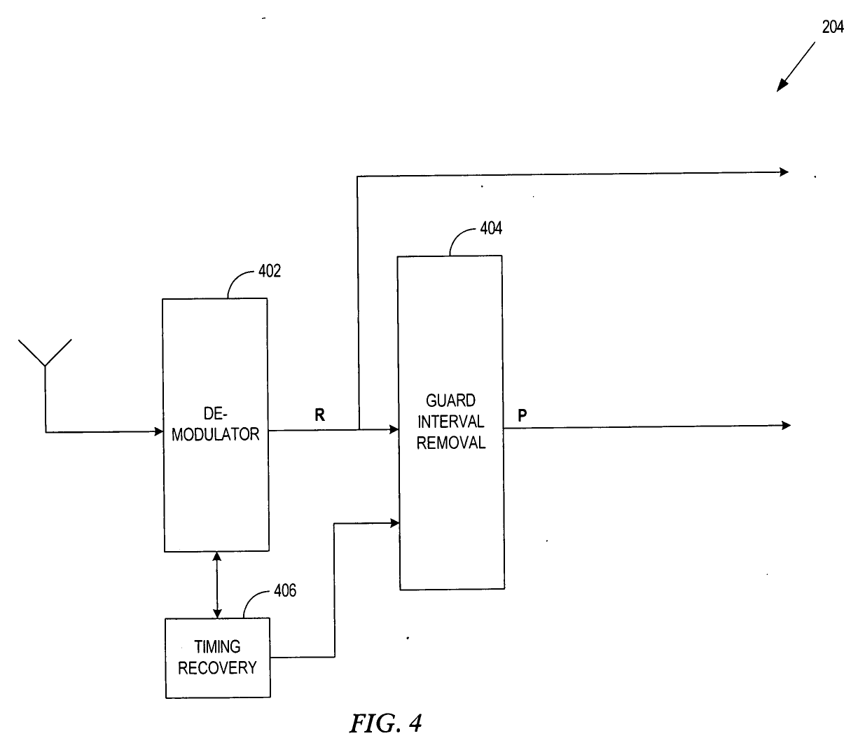

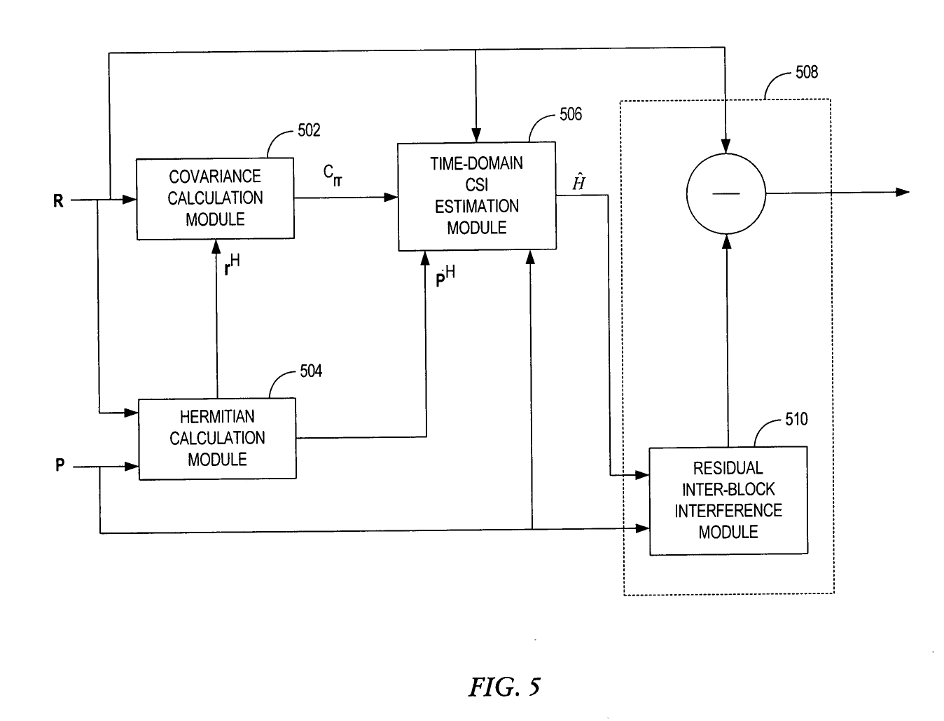

At the receiving end, either a mobile terminal receiver, or a base station receiver is configured to demodulate the signal transmitted by DKGII block 202 using demodulator 402 of DKGIR block 204 as exemplified in FIG. 4. Timing recovery block 406 is required to extract, inter alia, the spreading clock rate so that time coherent operations conducted by despreader (not shown) of demodulator block 402 may be facilitated. In particular, demodulator 402 reverses the modulation and up-conversion as applied by modulator 310 in order to reduce the transmitted signal to the stream of concatenated data blocks and associated GIs. GI removal block 404 is effective to separate the GI vector, P, from the received signal vector, R, as illustrated, for subsequent use by channel estimation block 206 and cyclic convolution restoral block 208 as exemplified in FIG. 5.

For the sake of simplicity of matrix expression, the channel impulse responses for consecutive symbols is taken to be h=[h₁ h₂ . . . h_{τmax}]. Thus, the i^{th} received signal vector at the input of de-modulator 402 may be defined as:

$$[ \begin{matrix}{y}^{i} \\ {v}^{i}\end{matrix} ] = {H}_{i}^{i} [ \begin{matrix}{x}^{i} \\ {p}^{i}\end{matrix} ] + {H}_{i - 1}^{i} [ \begin{matrix}{x}^{i - 1} \\ {p}^{i - 1}\end{matrix} ] + [ \begin{matrix}{n}_{y}^{i} \\ {n}_{v}^{i}\end{matrix} ] , \qquad ( 2 )$$

where xⁱ=[x₁ⁱ . . . xⱼⁱ . . . x_{M}ⁱ]^{T} is the symbol vector during the i^{th} block period, pᵢ=[pⁱᵢp₂ⁱ . . . pⱼⁱ . . . p_{L}ⁱ]^{T} is the vector of the fixed known GI with length L, y^{i=[y}₁ⁱy₂ⁱ . . . yⱼⁱ . . . y_{M}ⁱ]^{T} and vⁱ=[v₁ⁱv₂ⁱ . . . vⱼⁱ . . . v_{L}ⁱ]^{T} are the received signal vectors during the i^{th} block period, xⱼⁱ is the j^{th} data symbol of the i^{th} block, pⱼⁱ is the j^{th} symbol of the i^{th} known GI vector, and n_{y}ᵢ, nᵥⁱ are the noise vectors. All elements of noise vectors n_{y}ⁱ and nᵥⁱ have Independent Identical Distribution (IDD) with average power σ².

The channel impulse response matrix for the i^{th} block period may be formulated as:

$${H}_{i}^{i} = {[ \begin{matrix}{h}_{1 l}^{i} & & & & & & & \\ \cdot & {h}_{2 l}^{i} & & & & & 0 & \\ \cdot & \cdot & \cdot & & & & & \\ {h}_{1 L}^{i} & \cdot & \cdot & \cdot & & & & \\ & {h}_{2 L}^{i} & \cdot & \cdot & {h}_{Ml}^{i} & & & \\ & & \cdot & \cdot & \cdot & {h}_{( M + 1 ) l}^{i} & & \\ & 0 & & \cdot & \cdot & \cdot & \cdot & \\ & & & & {h}_{ML}^{i} & {h}_{( M + l ) ( L - l )}^{i} & \cdot & {h}_{( M + L ) l}^{i}\end{matrix} ]}_{( M + L ) ( M + L )} \qquad ( 3 )$$

and the residual channel impulse response matrix of the previous block period may be formulated as:

$${H}_{i - l}^{i} = {[ \begin{matrix}{h}_{( M + l ) L}^{i} & \cdot & {h}_{( M + L ) 2}^{i} \\ & \cdot & \cdot \\ 0 & & {h}_{( M + L ) L}^{i}\end{matrix} ]}_{( M + L ) ( M + L )} . \qquad ( 4 )$$

In addition, since the GI length is taken to be greater than the maximum delay spread, equation (2) may be simplified to:

$$[ \begin{matrix}{y}^{i} \\ {v}^{i}\end{matrix} ] = {H}_{i}^{i} [ \begin{matrix}{x}^{i} \\ {p}^{i}\end{matrix} ] + {H}_{i - 1}^{i} [ \begin{matrix}0 \\ {p}^{i - 1}\end{matrix} ] + [ \begin{matrix}{n}_{y}^{i} \\ {n}_{v}^{i}\end{matrix} ] , \qquad ( 5 )$$

where 0 is the zero vector having length M. Hence, the consecutive data blocks do not interfere with each other and, therefore, do not produce inter-block interference.

For simplicity of matrix expression, it is assumed that channel 120 is quasi-static during K consecutive symbol periods, thus the superscript in the channel information matrix may be ignored. By collecting all of the last elements of the received vector, vⁱ, from equation (5), we obtain the vector notation, v=Ph+n, having the following relationship:

$$[ \begin{matrix}{v}_{L}^{1} \\ {v}_{L}^{2} \\ \cdot \\ {v}_{L}^{K}\end{matrix} ] = [ \begin{matrix}{p}_{L}^{1} & {p}_{L - 1}^{1} & \cdot & {p}_{1}^{1} \\ {p}_{L}^{2} & \cdot & \cdot & \cdot \\ \cdot & \cdot & \cdot & \cdot \\ {p}_{L}^{K} & \cdot & \cdot & {p}_{1}^{K}\end{matrix} ] [ \begin{matrix}{h}_{1} \\ {h}_{2} \\ \cdot \\ {h}_{L}\end{matrix} ] + [ \begin{matrix}{n}_{vL}^{1} \\ {n}_{vL}^{2} \\ \cdot \\ {n}_{vL}^{K}\end{matrix} ] , \qquad ( 6 )$$

where v_{L}ⁱ is the last element of the received vector for the i^{th} block.

By defining the number of consecutive blocks using DKGI to be equal to the length of the GI, i.e., K=L, then matrix P is made to be full rank by designing each row of matrix P with linearly independent GI sequences, or other sequences that may be known to DKGIR block 204 of FIG. 2. Thus, DKGI generator 308 of FIG. 3 may be configured to generate the linearly independent GI sequences, or other sequences, as required to make matrix P full rank. Such sequences, for example, may be Pseudorandom Number (PN) sequences generated by a Linear Feedback Shift Register (LFSR). Such PN sequences may be designed having lengths equal to m=2ⁿ−1, where n is the number of registers implemented by the LFSR. Sequence lengths may be extended to have an even length by adding a “0” bit to the sequence just prior to the epoch event of the sequence. That is to say, that PN sequences are periodic with period m. Thus, just prior to the sequence repetition, a “0” may be inserted into the sequence to generate length m′=2ⁿ n with no loss of its linearly independent qualities.

In such an instance, the CSI can be estimated using Minimum Mean Squared Error (MMSE) criteria as follows:
\check{h}=CᵣᵣP^{H}[PCᵣᵣP^{H}+R_{n]}⁻¹v, (7)
where

$${C}_{rr} = \frac{1}{K} {\sum }_{i = 1}^{K} r ( i \times ( M + L ) - 1 ) {r}^{H} ( i \times ( M + L ) - 1 )$$

is the covariance matrix for the L channel information variables, which also can be seen as an identical matrix when the channel information is unknown. It should be noted, that while MMSE criteria may be used to estimate the CSI, other techniques such as a zero-forcing technique may also be used.

Due to the relatively small size of matrix P and the identical matrix, Cᵣᵣ, the CSI can be estimated in the time domain with relatively low complexity as illustrated in FIG. 5. In particular, in order to calculate the covariance matrix for the L channel information variables, covariance calculation module 502 performs a product of the (M+L−1) elements of the i^{th} received vector, r, with the (M+L−1) elements of the i^{th} conjugate transposition of the received vector, r^{H}, as generated by hermitian calculation module 504. Each i^{th} product is summed over K received blocks and normalized by K to finally achieve covariance matrix Cᵣᵣ. As can be seen, therefore, K*(M+L−1) multiplications and K additions are required to generate the CSI information in the time-domain as generated by time-domain CSI information module 506.

It should be noted that while the CP and ZP schemes require pilot signals to be transmitted in order for the receiver to generate reasonable channel estimates, the DKGI method in accordance with the present invention does not. Instead, the present invention makes use of the guard interval information that is already required in order to prevent the ISI and ICI phenomenon. Accordingly, there is no need for the pilot signals to be transmitted in the frequency domain, which greatly enhances channel capacity.

Due to the different known guard interval used for consecutive data blocks, however, the linear convolution of the channel in the time-domain cannot be transformed into cyclic convolution in a straightforward manner. For purposes of simplifying the frequency domain equalization implemented by equalizer 214 of FIG. 2, cyclic convolution should be restored with the estimated knowledge of the CSI and GI in consecutive block periods as is performed by cyclic convolution restoral block 508 of FIG. 5.

For the purpose of cyclic convolution restoration, equation (5) may be modeled as:

$$[ \begin{matrix}{y}^{i} \\ {v}^{i}\end{matrix} ] = ( {H}_{i}^{i} + {H}_{i - 1}^{i} ) [ \begin{matrix}{x}^{i} \\ {p}^{i}\end{matrix} ] + {H}_{i - 1}^{i} [ \begin{matrix}0 \\ {p}^{i - 1} - {p}^{i}\end{matrix} ] + [ \begin{matrix}{n}_{y}^{i} \\ {n}_{v}^{i}\end{matrix} ] , \qquad ( 8 )$$

where (Hᵢⁱ+Hᵢ₋₁ⁱ) is the cyclic convolution matrix and the second term is the residual inter-block interference. Thus, residual inter-block interference module 510 generates the second term of equation (8) so that the difference between the received vector, R, and the residual inter-block interference term may be calculated to generate the channel matrix for the i^{th} data block as follows:

$$\begin{matrix}{\tilde{H}}_{i} = {H}_{i}^{i} + {H}_{i - 1}^{i} \\ = {[ \begin{matrix}{h}_{1 l}^{i} & & & & & {h}_{( M + l ) L}^{i} & \cdot & {h}_{( M + L ) 2}^{i} \\ \cdot & {h}_{2 l}^{i} & & & & & \cdot & \cdot \\ \cdot & \cdot & \cdot & & & 0 & & {h}_{( M + L ) L}^{i} \\ {h}_{1 L}^{i} & \cdot & \cdot & \cdot & & & & \\ & {h}_{2 L}^{i} & \cdot & \cdot & {h}_{Ml}^{i} & & & \\ & & \cdot & \cdot & \cdot & {h}_{( M + 1 ) l}^{i} & & \\ & 0 & & \cdot & \cdot & \cdot & \cdot & \\ & & & & {h}_{ML}^{i} & {h}_{( M + l ) ( L - l )}^{i} & \cdot & {h}_{( M + L ) l}^{i}\end{matrix} ]}_{( M + L ) ( M + L )}\end{matrix} \qquad ( 9 )$$

It can be seen, therefore, that the complexity of cyclic convolution restoral block 508 yields (L−1)L/2 complex multiplications and (L+1)L/2 complex additions.

In performing frequency-domain equalization as in block 214 of FIG. 2, the received spectral coefficient blocks, i.e., after DKGI removal as in block 204 and FFT processing as in blocks 210 and 212, are adjusted to compensate for the frequency response of the channel. Due to the DKGI based cyclic restoration performed by block 208, each block is deemed to have undergone cyclic convolution with the channel's impulse response as described by equation (9). In the frequency domain, this is the same as if the spectral coefficient blocks were pointwise multiplied by the frequency response of the channel. Thus, it is possible to remove the effect of the channel's filter simply through knowledge of equation (9). In particular, since channel 220 has pointwise multiplied the spectral coefficient blocks by its frequency response, all that needs to be done is multiply the spectral coefficient blocks pointwise by one over the frequency response as performed by equalization block 214.

The present invention assumes that the length of the DKGI and the number of consecutive data blocks is equal to the maximum delay spread, i.e., L=K=τ_{K}. In addition, the channel is assumed to be quasi-static during consecutive block periods, which may be unrealistic in practical environments. In other embodiments in accordance with the present invention, therefore, the actual length of the DKGI and the number of consecutive data blocks may be defined to reach the best tradeoff between the channel capacity waste and end user mobility. In such an instance, assuming that the actual GI is greater than the maximum delay spread, i.e., L=τ_{K}+D, then only K=ROUND(τ_{K}/2^{D}) consecutive data blocks are needed for DKGI design, time-domain channel estimation, and cyclic convolution restoration.

As discussed above, DKGI in accordance with the present invention is effective to increase channel capacity over other methods employing frequency domain pilot signals. For example, increased capacity gains realized by the DKGI method over the OFDM with CP method is 1.6% using 16 pilot signals and 14.3% using 128 pilot signals. Similarly, increased capacity gains of 3.1% and 22.2% may be realized over the SCCP method for 16 and 128 pilot signals used, respectively.

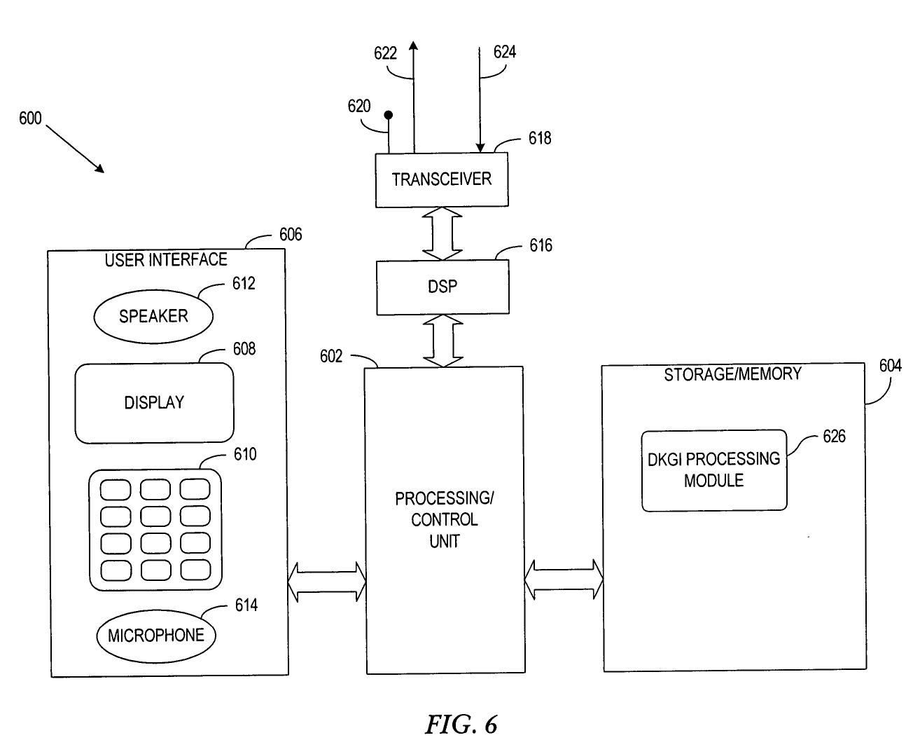

The invention is a modular invention, whereby processing functions within a mobile device or a land based communication system may be used. The mobile devices may be any type of wireless device, such as wireless/cellular telephones, personal digital assistants (PDAs), or other wireless handsets, as well as portable computing devices capable of wireless communication in accordance with the present invention. These landline and mobile devices utilize computing circuitry and software to control and manage the conventional device activity as well as the functionality provided by the present invention. Hardware, firmware, software or a combination thereof may be used to perform the DKGI functions described herein. An example of a representative mobile terminal computing system capable of carrying out operations in accordance with the invention is illustrated in FIG. 6. Those skilled in the art will appreciate that the exemplary mobile computing environment 600 is merely representative of general functions that may be associated with such mobile devices, and also that landline computing systems similarly include computing circuitry to perform such operations.

The exemplary mobile computing arrangement 600 suitable for providing DKGI based circular convolution restoral and frequency domain equalization in accordance with the present invention may be associated with a number of different types of wireless devices. The representative mobile computing arrangement 600 includes a processing/control unit 602, such as a microprocessor, reduced instruction set computer (RISC), or other central processing module. The processing unit 602 need not be a single device, and may include one or more processors. For example, the processing unit may include a master processor and associated slave processors coupled to communicate with the master processor.

The processing unit 602 controls the basic functions of the mobile terminal, and also those functions associated with the present invention as dictated by DKGI module 626 available in the program storage/memory 604. Thus, the processing unit 602 is capable of performing frequency domain equalization on received transmissions experiencing multi-path fading through implementation of a DKGI based circular convolution restoral as discussed above in relation to FIGS. 2, and 4-5. In addition, the processing unit in combination with DKGI module 626 is capable of appending sets of DKGIs to the variable number of concatenated data blocks as discussed above in relation to FIGS. 2-3 to aid the receiving entity in performing frequency domain equalization in accordance with the present invention. The program storage/memory 604 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 604 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 600 via data signals, such as being downloaded electronically via one or more networks, such as the Internet and an intermediate wireless network(s).

The processor 602 is also coupled to user-interface 606 elements associated with the mobile terminal. The user-interface 606 of the mobile terminal may include, for example, a display 608 such as a liquid crystal display, a keypad 610, speaker 612, and microphone 614. These and other user-interface components are coupled to the processor 602 as is known in the art. Other user-interface mechanisms may be employed, such as voice commands, switches, touch pad/screen, graphical user interface using a pointing device, trackball, joystick, or any other user interface mechanism.

The mobile computing arrangement 600 also includes conventional circuitry for performing wireless transmissions. A digital signal processor (DSP) 616 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 618, generally coupled to an antenna 620, transmits the outgoing radio signals 622 and receives the incoming radio signals 624 associated with the wireless device.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a communication system and method in accordance with the present invention.

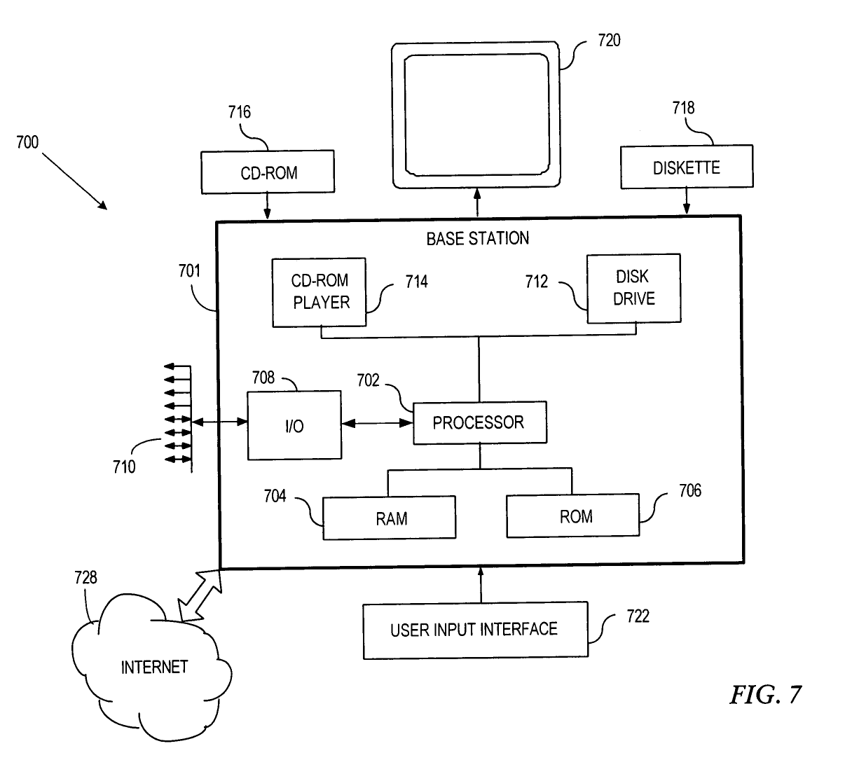

The multiple access base stations for providing communication functions in connection with the present invention may be any type of computing device capable of processing and communicating two-way information. An example of a representative computing system capable of carrying out operations in accordance with the invention is illustrated in FIG. 7. Hardware, firmware, software or a combination thereof may be used to perform the various communications functions and operations described herein. The computing structure 700 of FIG. 7 is an example computing structure that can be used in connection with such a communication system.

The example computing arrangement 700 suitable for performing the communications activity in accordance with the present invention includes the base station 701, which includes a central processor (CPU) 702 coupled to random access memory (RAM) 704 and read-only memory (ROM) 706. The ROM 706 may also be other types of storage media to store programs, such as programmable ROM (PROM), erasable PROM (EPROM), etc. The processor 702 may communicate with other internal and external components through input/output (I/O) circuitry 708 and bussing 710, to provide control signals and the like. For example, the transmission and reception functions exemplified in FIG. 2 may be performed by base station 701. Further, I/O circuitry 708 may also communicate with base station controllers and the like to carry out base station functionality in accordance with the present invention.

The base station 701 may also include one or more data storage devices, including hard and floppy disk drives 712, CD-ROM drives 714, and other hardware capable of reading and/or storing information such as DVD, etc. In one embodiment, software for carrying out the communication operations in accordance with the present invention may be stored and distributed on a CD-ROM 716, diskette 718 or other form of media capable of portably storing information. These storage media may be inserted into, and read by, devices such as the CD-ROM drive 714, the disk drive 712, etc. The software may also be transmitted to the base station 701 via data signals, such as being downloaded electronically via a network, such as the Internet 728. The base station 701 is coupled to a display 720, which may be any type of known display or presentation screen, such as LCD displays, plasma display, cathode ray tubes (CRT), etc. A user input interface 722 is provided, including one or more user interface mechanisms such as a mouse, keyboard, microphone, touch pad, touch screen, voice-recognition system, etc.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

What is claimed is:

1. A method of performing Frequency Domain Equalization (FDE), the method comprising:
receiving a variable number of concatenated data blocks;
receiving a Different Known Guard Interval (DKGI) appended to each one of the concatenated data blocks;
estimating Channel State Information (CSI) of the channel in the time-domain using the received DKGI; and
restoring cyclic convolution using the estimated CSI and the received DKGI to facilitate frequency domain equalization

2. The method of claim 1, wherein the variable number of concatenated data blocks is proportional to a Doppler frequency of the channel.

3. The method of claim 1, wherein a length of the DKGI is proportional to a maximum delay spread of the channel.

4. The method of claim 1, wherein the DKGI is formed using linearly independent sequences.

5. The method of claim 4, wherein the linearly independent sequences are formed using a Linear Feedback Shift Register (LFSR).

6. The method of claim 1, wherein restoring cyclic convolution comprises generating a residual inter-block interference term from the received DKGI and the estimated CSI.

7. The method of claim 6, wherein restoring cyclic convolution further comprises subtracting the residual inter-block interference term from a received signal vector.

8. A communication system adapted to remove multipath fading effects of a communication channel from a received transmission signal, the communication system comprising:
a transmitter coupled to the communication channel and adapted to append a variable number of data blocks with Different Known Guard Intervals (DKGI) to form the transmission signal; and
a receiver coupled to receive the transmission signal from the communication channel and adapted to separate the data blocks from the DKGI, the receiver including,
a channel state estimation module coupled to receive the DKGI and adapted to estimate channel state information in the time domain from the DKGI; and
a cyclic convolution restoration module coupled to the channel state estimation module and adapted to restore cyclic convolution using the estimated channel state information and the DKGI.

9. The communication system of claim 8, wherein the transmitter comprises a block generator coupled to receive a generated data stream and adapted to generate the variable number of data blocks from the generated data stream.

10. The communication system of claim 9, wherein the transmitter further comprises a DKGI generation module adapted to generate one DKGI for each data block generated by the block generator.

11. The communication system of claim 10, wherein the transmitter further comprises a guard interval append module coupled to the block generator and the DKGI generation module and adapted to combine each data block with its associated DKGI to form the transmission signal.

12. The communication system of claim 8, wherein the receiver further includes a guard interval removal module adapted to receive the transmission signal and adapted to separate the DKGIs and data blocks from the received transmission signal.

13. The communication system of claim 8, wherein the cyclic convolution restoration module comprises a residual inter-block interference module adapted to generate a residual inter-block interference term from the DKGIs and the estimated channel state information, the residual inter-block interference term being subtracted from the received transmission signal to restore cyclic convolution.

14. A mobile terminal capable of being wirelessly coupled to an entity within a communication system, the mobile terminal comprising:
a memory capable of storing a Different Known Guard Interval (DKGI) module;
a processor coupled to the memory and adapted by the DKGI module to append a first set of DKGIs to a first variable number of data blocks to form a first transmission signal; and
a transceiver configurable to transmit the first transmission signal to the entity, the transceiver including a receiver coupled to receive a second transmission signal from the entity having a second set of DKGIs and adapted by the processor to estimate channel state information in the time domain from the second set of DKGIs and further adapted to restore cyclic convolution using the estimated channel state information and the second set of DKGIs.

15. The mobile terminal of claim 14, wherein the receiver comprises a guard interval removal module adapted to receive the second transmission signal and adapted to separate the second set of DKGIs from a second variable number of data blocks received from the entity.

16. The mobile terminal of claim 15, wherein the cyclic convolution restoration module comprises a residual inter-block interference module adapted to generate a residual inter-block interference term from the second set of DKGIs and the estimated channel state information, the residual inter-block interference term being subtracted from the received second transmission signal to restore cyclic convolution.

17. A computer-readable medium having instructions stored thereon which are executable by a mobile terminal for substantially equalizing multipath effects on a signal received from a transmitting entity via a channel by performing steps comprising:
separating a Different Known Guard Interval (DKGI) from each one of a variable number of data blocks transmitted by the entity;
estimating Channel State Information (CSI) of the channel in the time-domain using the DKGI; and
restoring cyclic convolution using the estimated CSI and DKGI to facilitate frequency domain equalization.

18. The computer-readable medium of claim 17, wherein the step of restoring cyclic convolution comprises the step of generating a residual inter-block interference term from the estimated CSI and the DKGI.

19. The computer-readable medium of claim 18, wherein the step of restoring cyclic convolution further comprises the step of subtracting the residual inter-block interference term from a signal vector received from the entity.

20. A base station within a wireless communication network adapted to receive transmissions from a mobile terminal, the base station comprising:
a receiver adapted to separate a variable number of data blocks from respective Different Known Guard Intervals (DKGI) received from the mobile terminal, the receiver including,
a channel state estimation module adapted to estimate channel state information in the time domain from the DKGIs; and
a cyclic convolution restoration module coupled to the channel state estimation module and adapted to restore cyclic convolution using the estimated channel state information and the DKGIs.

21. The base station of claim 20, wherein the cyclic convolution restoration module comprises a residual inter-block interference module adapted to generate a residual inter-block interference term from the estimated channel state information and the DKGIs, the inter-block interference term being subtracted from the received transmission signal to restore cyclic convolution.

22. A computer-readable medium having instructions stored thereon which are executable by a base station for substantially equalizing multipath effects on a signal received from a mobile terminal via a channel by performing steps comprising:
separating a Different Known Guard Interval (DKGI) from each one of a variable number of data blocks transmitted by the mobile terminal;
estimating Channel State Information (CSI) of the channel in the time-domain using the DKGI; and
restoring cyclic convolution using the estimated CSI and DKGI to facilitate frequency domain equalization.

23. The computer-readable medium of claim 22, wherein the step of restoring cyclic convolution comprises the step of generating a residual inter-block interference term from the estimated CSI and the DKGI.

24. The computer-readable medium of claim 23, wherein the step of restoring cyclic convolution further comprises the step of subtracting the residual inter-block interference term from a signal vector received from the mobile terminal.
